(19) United States
(12) Patent Application Publication
(10) Pub. No.: US 2026/0001266 A1
(43) Pub. Date: Jan. 1, 2026

(54) FILTERING DEVICE FOR FILTERING A FLUID AND A METHOD FOR VENTING AND BACKFLUSHING

(71) Applicant: Nordson Corporation, Westlake, OH (US)

(72) Inventors: Rolf SCHAMANN, Munster (DE); Uwe WOLTER, Dortmund (DE)

(73) Assignee: Nordson Corporation, Westlake, OH (US)

(21) Appl. No.: 19/111,400

(22) PCT Filed: Sep. 20, 2023
(86) PCT No.: PCT/US2023/074643

§ 371 Date: Mar. 13, 2025

(30) Foreign Application Priority Data
Sep. 21, 2022 (DE) 10 2022 124 308.7

(51) Int. Cl. B29C 48/691; B29C 48/27

(52) U.S. Cl. CPC B29C 48/6912; B29C 48/273; B29C 2948/92019; B29C 2948/92466

(57) ABSTRACT

A device may include a housing having a receptacle for receiving a screen carrier, and having a fluid inlet channel and a fluid outlet channel. In addition, the device may include a screen carrier movably received inside the receptacle and having a screen carrier inlet, a screen carrier outlet and a cavity for receiving a filter element, where the cavity is in fluid communication with the screen carrier inlet and the screen carrier outlet. The screen carrier can be moved from a screen replacement position(S) via a venting position area into a filtering position (F). Moreover, the device may include an accumulator which is fluidically connectable to the screen carrier inlet and/or to the screen carrier outlet and which is configured to store fluid that is fed via the screen carrier inlet and/or the screen carrier outlet and to control a feeding of the fluid into the accumulator.

### CROSS-REFERENCE TO RELATED APPLICATIONS

This application is a National Stage Application of International Patent App. No. PCT/US2023/074643, filed Sep. 20, 2023, which claims priority to German Patent Application No. 102022124308.7, filed Sep. 21, 2022, the entire disclosures of both of which are hereby incorporated by reference as if set forth in their entirety herein.

### FIELD OF THE DISCLOSURE

The invention relates to a filtering device for filtering a fluid, in particular a liquefied plastic, comprising a housing having a receptacle for receiving a screen carrier and having a fluid inlet channel and a fluid outlet channel, a screen carrier movably received along a longitudinal axis inside the receptacle and having a screen carrier inlet, a screen carrier outlet and a cavity for receiving a filter element, wherein the cavity is in fluid communication with the screen carrier inlet and the screen carrier outlet, and wherein the screen carrier can be moved from a screen replacement position via a venting position area into a filtering position. The invention further relates to methods therefor.

Filtering devices are used in plastics processing machines, for example, when the purity of the plastic being processing must meet tough requirements. They are typically arranged between an extruder, which melts and conveys the plastic, and an applicator. Such filtering devices for filtering a fluid, in particular a liquefied plastic, and methods therefor are known from the prior art and have a screen carrier in which a filtering element, also referred to as a screen, is arranged.

Such filtering or filter elements must be replaced or cleaned when they have been in operation for some time. To replace the filter element, the screen carrier is moved from the filtering position, also known as the production position, into a screen replacement position in which the filter element can be accessed and replaced.

Once the filter element has been replaced, it must be brought back into the production process. The basic challenge this poses is that the interior spaces of the screen carrier, referred to as cavities, are typically filled with air after replacement of the screen and that it is essential to prevent air from being introduced into the stream of plastic fluid. After replacement of the screen, the screen carrier is firstly moved for that reason into a venting position area in which liquefied plastic flows into the screen cavity and displaces the air contained therein to the outside via venting channels.

In most cases, the plastic used for backflushing is taken from the plastic fluid stream to be filtered. This aspect also plays a role in the backflushing of filter elements, in which the latter are backflushed, in the opposite direction to the filtering direction, using clean or cleaned plastic melt, in order to clean them. The plastic used for backflushing is likewise taken in most cases from the plastic fluid stream to be filtered, in the form of a volumetric flow. This volumetric flow is generally regulated and kept within limits by changes in the pressure level. However, there are limits to this regulation of pressure levels. If the stream of plastic fluid is vented or backflushed too fast, this can have a negative impacts on the volumetric flow rate of the plastic and on the system pressure. When using spinning nozzles, for example, such fluctuations in pressure can have an adverse effect on the spinning process. The product quality can suffer, or the spun threads can even break.

In order to mitigate or even completely prevent these negative consequences, opening a venting/backflushing channel, via which the venting or backflush fluid is fed or discharged, only partially in order to control the overall system pressure is known from the prior art. However, if there are very high system pressures, or the viscosity of the melt is very low, this approach comes up against limits. It may not be possible to ensure the prevention of pressure fluctuations. Depending on the properties of the melt, it may also be necessary to open the backflush channel only very slightly, i.e. with a small opening cross-section. However, this can result in larger dirt particles clogging the cross-section, which also means that the pressure cannot be regulated in the ideal manner.

Given this background, the object of the invention is to develop a filtering device and a method of the kind initially specified in such a way that the disadvantages identified in the prior art are eliminated as far as possible. In particular, the object of the invention is to specify a filtering device and a filtering method, in which the volumetric flow rate of the melt leaving the filtering device, and the overall system pressure, are kept as constant as possible during the screen replacement operation or during backflushing of a filter element, and in which the filtering device has a lower overall system complexity.

### SUMMARY OF THE DISCLOSURE

According to the invention, the object is achieved in a filtering device of the kind initially specified by an accumulator which is fluidically connectable to the screen carrier inlet and/or to the screen carrier outlet and which is configured to store fluid that is fed via the screen carrier inlet and/or the screen carrier outlet and to control the feeding of the fluid into the accumulator in such a way that the volumetric flow rate of the melt, in particular the volumetric flow rate of the melt that leaves the filtering device and is fed to downstream system components, stays within a definable range of volumetric flow rate.

The invention makes use of the knowledge that, by controlling how the fluid is fed into the accumulator, for example in the form of a volumetric flow or mass flow, the cavity can be vented reliably even at high outlet-side pressures and low viscosities. Typically, the fluid used for venting or backflushing is fed to the accumulator, received in the latter and released to the surroundings after venting or backflushing. By controlling how the fluid is fed to the accumulator, the overall system pressure can be kept within closely definable limits, and it is possible to ensure a constant volumetric flow rate of the melt leaving the filtering device and fed to downstream system components. In a sense, therefore, the accumulator performs the function of a hydraulic arrester when the cavity is vented or backflushed, with the result that material passes through the cavity in a finely metered manner. Filtering devices according to the invention are also suitable for large pressure and viscosity ranges in respect of the melt to be processed. The accumulator is preferably an accumulator through which there is a non-permanent flow. A downstream system component is understood to be a component that is arranged downstream from the filtering device. It can be a forming tool, for example.

The invention is developed by the filtering device having a control unit which is configured to control the feeding of fluid into the accumulator in such a way that a volumetric flow rate of the melt, in particular a volumetric flow rate of the melt that leaves the filtering device and is fed to downstream system components, stays within a definable range of volumetric flow rate. With the aid of the control unit according to the invention, the feeding of the fluid into the accumulator, for example with a mass or volumetric flow rate, is controlled in such a way that the volumetric flow rate of the melt stays overall within a definable range of volumetric flow rate. As a result, the system pressure and the overall system pressure stay within a within a definable pressure range.

According to a preferred embodiment, changes in the volumetric flow rate of the melt are determined, alternatively, by means of a pressure sensor which is preferably arranged in the filtering device, in particular in the fluid outlet channel. The volumetric flow rate of the melt is preferably determined on the basis of the system pressure, which is determined here as an auxiliary variable. In other words, by measuring the pressure by means of the pressure sensor, conclusions can be drawn about the volumetric flow rate of the melt through the filtering device or the system as a whole, as changes in the volumetric flow rate invariably lead to changes in pressure. According to one embodiment, the pressure is not necessarily measured in the filtering device, but can also be measured at any expedient location elsewhere in the system. According to one embodiment, the pressure is measured on the downstream side of the filtering device and on the inlet side of a forming tool or downstream pressure generator.

The invention is developed by arranging the accumulator in a separate housing or in the screen carrier housing. If the accumulator is arranged in a separate housing, this provides the advantage that existing devices can be extended with the respective accumulator without costly or time-consuming modifications being required. If the accumulator is arranged directly in the housing of the filtering device, a particularly compact filtering device can be specified.

According to a further embodiment, the housing has an accumulator connecting channel which fluidically connects the screen carrier inlet to an accumulator inlet, depending on the position of the screen carrier relative to the housing. The screen carrier is preferably vented in the venting position area by feeding a fluid via the fluid outlet channel, wherein the accumulator connecting channel provides fluid communication between the screen carrier inlet and the inlet of the accumulator in the venting position area.

Fluid used for venting, in particular plastic melt, as well as any air pockets thus reach the accumulator via the accumulator connecting channel and can be received therein.

The invention is developed by the screen carrier being movable into a backflush position area in which backflush fluid is fed to the filter element from the clean side of the filter element to the dirt side of the filter element, wherein the accumulator connecting channel provides fluid communication, in the backflush position area, between the screen carrier inlet and the inlet of the accumulator. In this way, fluid used for backflushing, which typically contains the impurities previously contained in the screen, can also be fed to the accumulator and received therein.

The screen carrier preferably has an outlet channel that provides the accumulator connecting channel with fluid communication with surroundings of the filtering device when the screen carrier is in an accumulator emptying position, such that fluid received in the accumulator can be discharged to the surroundings, and wherein the accumulator connecting channel is disconnected from the screen carrier inlet in the accumulator emptying position. This allows the accumulator to be emptied towards surroundings of the filtering device. In this case, the accumulator connecting channel is disconnected from the screen carrier inlet, thus ensuring that the fluid received in the accumulator is not returned to the system.

According to a preferred embodiment, the accumulator emptying position of the screen carrier matches the filtering position of the screen carrier. This means that, after venting or backflushing the cavity by moving the screen carrier into the filtering position, the screen carrier performs its filtering function while at the same time, in the filtering position matching the accumulator emptying position, the accumulator is connected to the surroundings of the filtering device via the outlet channel, such that, in the filtering position, fluid can be discharged from the accumulator to the surroundings. There is therefore functional integration here, in other words. Moving the screen carrier brings it into the filtering position, while at the same time connecting the accumulator to the surroundings. No additional valves or the like are needed in this configuration.

The invention is developed by embodying the accumulator as a piston accumulator. The piston accumulator preferably has an accumulator chamber and a piston which is arranged in the accumulator chamber and can be driven by an actuator, the feeding of the fluid into the accumulator being controlled by the piston. The actuator is preferably embodied as a lift cylinder which is configured to drive the piston along the longitudinal axis of the accumulator. In the present embodiment, the mass or volumetric flow fed to the accumulator is thus controlled by driving the piston along the longitudinal axis of the accumulator. At the same time, by driving it in the opposite direction, the piston can be used to expel the fluid received in the accumulator out of the accumulator, for example towards surroundings of the filtering device.

According to an alternative embodiment, the actuator is embodied as a rotary lift cylinder which is configured to drive the piston along the longitudinal axis of the accumulator and rotationally inside the accumulator chamber, wherein the piston has a longitudinal groove which interacts in such a way with a piston accumulator inlet and a piston accumulator outlet that fluid communication with the piston accumulator inlet or the piston accumulator outlet is released according to the rotational position of the piston. The piston thus performs two functions, in a sense: firstly, the piston allows controlled and well-metered entry of fluid into the accumulator chamber and, by movement of the piston in the opposite direction, it also allows the fluid to be removed from the accumulator chamber, while at the same, by due to rotation of the piston, either the piston accumulator inlet or the piston accumulator outlet is released, which means that no additional valves are needed in the area of the inlet or the outlet.

According to another alternative embodiment, the piston accumulator has a piston accumulator outlet and a valve having a valve pin, wherein the piston accumulator outlet is blocked or released according to the position of the valve pin relative to the piston accumulator outlet. According to a preferred embodiment, the accumulator has a control valve which is connected to the accumulator chamber and is configured to apply pressure to the accumulator chamber or to vent it. In this way, it is possible for the accumulator to be prepared for its respective use before it is used to vent or backflush.

The invention is developed by the screen carrier being a first screen carrier, wherein the filtering device has at least a second screen carrier movably received in the housing and having a second screen carrier inlet, a second screen carrier outlet and a second cavity for receiving a second filter element, wherein the housing has at least a second accumulator connecting channel which fluidically connects the second screen carrier inlet to the inlet of the accumulator, depending on the position of the second screen carrier relative to the housing. By providing the additional screen carrier, it is possible to ensure that the filtering device has permanent operability. For example, while a first screen carrier is in a venting or backflushing position, the other screen carrier can ensure that filtration is operating, and vice versa. According to a preferred embodiment, the filtering device has three of more screen carriers which are embodied analogously to the first two screen carriers and which are movably received in the housing. Each screen carrier can have one or more cavities.

The invention has been described above with reference to a filtering device. In a second aspect, the invention relates to a method for venting a filtering device, in particular a filtering device according to any one of the embodiments above. According to the invention, the method comprises the steps of: moving a screen carrier of the filtering device into a venting position area, feeding venting fluid via a fluid outlet channel of the filtering device, such that the air in the cavity of the screen carrier is displaced towards a screen carrier inlet, feeding the displaced air and/or the venting fluid from the screen carrier inlet to an accumulator, wherein the feeding of the fluid into the accumulator is controlled in such a way that a volumetric flow rate of the melt, in particular a volumetric flow rate of the melt that leaves the filtering device and is fed to downstream system components, stays within a definable range of volumetric flow rate. The system pressure thus stays within definable limits when the screen carrier is vented via the screen carrier outlet.

In a third aspect, the invention relates to a method for venting a filtering device, in particular a filtering device according to any one of the above embodiments. The method according to the third aspect of the invention comprises the steps of:
moving a screen carrier of the filtering device into a venting position area, feeding venting fluid via a fluid inlet channel of the filtering device, such that the air in the at least one cavity of the screen carrier is displaced towards a screen carrier outlet, feeding the displaced air and/or the venting fluid from the screen carrier outlet to an accumulator, wherein the feeding of the fluid into the accumulator is controlled in such a way that a volumetric flow rate of the melt, in particular a volumetric flow rate of the melt that leaves the filtering device and is fed to downstream system components, stays within a definable range of volumetric flow rate. The method according to the third aspect is an alternative solution to the method according to the second aspect; in the method according to the third aspect, venting fluid is fed via the fluid inlet channel and transferred to the accumulator via the screen carrier outlet. The method according to the third aspect utilizes the same advantages and preferred embodiments as the filtering device according to the invention and the method according to the second aspect. Reference is made in this regard to the observations above, the content of which is incorporated here by reference.

In a fourth aspect, the invention relates to a method for backflushing a filtering device, in particular a filtering device according to any one of the above embodiments. The method comprises the steps of: moving a screen carrier of the filtering device into a backflush position area, feeding backflush fluid via a fluid outlet channel of the filtering device, such that backflush fluid is fed to a filter element from the clean side of the filter element to the dirt side and the backflushed fluid is pressed towards a screen carrier inlet, feeding the backflushed fluid from the screen carrier inlet to an accumulator, wherein the feeding of the fluid into the accumulator is controlled in such a way that a volumetric flow rate of the melt, in particular a volumetric flow rate of the melt that leaves the filtering device and is fed to downstream system components, stays within a definable range of volumetric flow rate.

This ensures, also during backflushing, that the volumetric flow rate of the melt leaving the filtering device and fed to downstream system components, and hence also the overall system pressure, stays within a definable range, thus ensuring the desired product quality over a large range of operating pressures and viscosities. The method according to the fourth aspect utilizes the same advantages and preferred embodiments as the filtering device according to the invention and the method according to the second and third aspect. Reference is made in this regard to the observations above, the content of which is incorporated here by reference.

The method is developed by the steps of: closing an inlet of the accumulator, opening an outlet of the accumulator, discharging the fluid contained in the system out of the accumulator via the outlet.

The method is further developed by performing the steps of closing the inlet and opening the outlet by moving the screen carrier into an accumulator emptying position in which an accumulator connecting channel provides fluid communication between the accumulator and surroundings of the filtering device and the screen carrier inlet is disconnected. This ensures that no fluid enters the process when fluid is expelled from the accumulator.

Further features and advantages of the invention ensue from the attached claims and the following description, in which embodiments are described in more detail with reference to schematic drawings.

### BRIEF DESCRIPTION OF THE DRAWINGS

In the Figures,

FIG. 1a shows a first embodiment of a filtering device according to the invention;

FIG. 1b shows a detail “X” of the filtering device according to FIG. 1a, in particular a detail of the melt accumulator;

FIG. 2 shows the embodiment of the filtering device according to the invention, in a filter or accumulator emptying position;

FIGS. 3 and 4 show the embodiment of the filtering device according to the invention in a venting position area;

FIG. 5 shows the embodiment of the filtering device according to the invention in a backflushing position;

FIGS. 6 and 7 show the embodiment of the filtering device according to the invention in an accumulator emptying position or filtering position;

FIGS. 8a, 8b, and 8c show cross-sectional views of an alternative embodiment of the accumulator according to the invention;

FIGS. 9a and 9b show a cross-sectional views of an alternative embodiment of the accumulator according to the invention;

FIGS. 10, 11, and 12 show block diagrams of the methods according to the invention.

### DETAILED DESCRIPTION

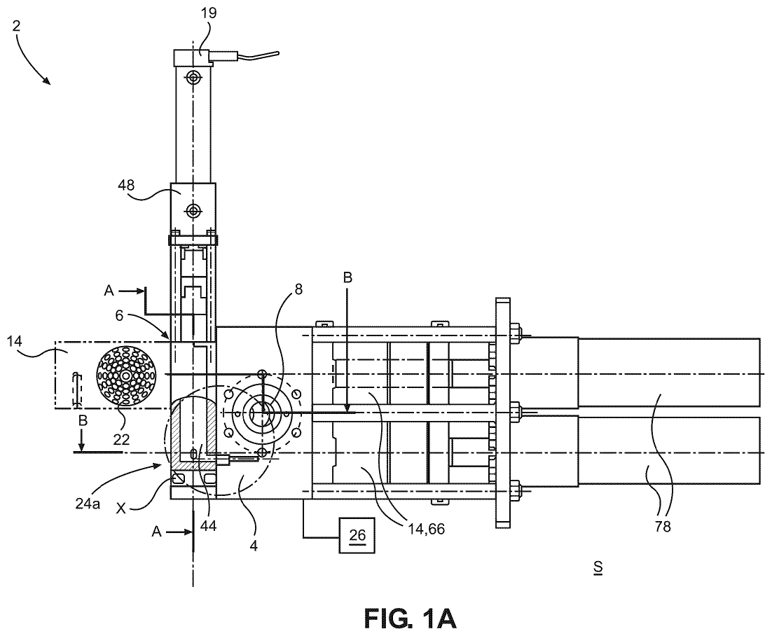

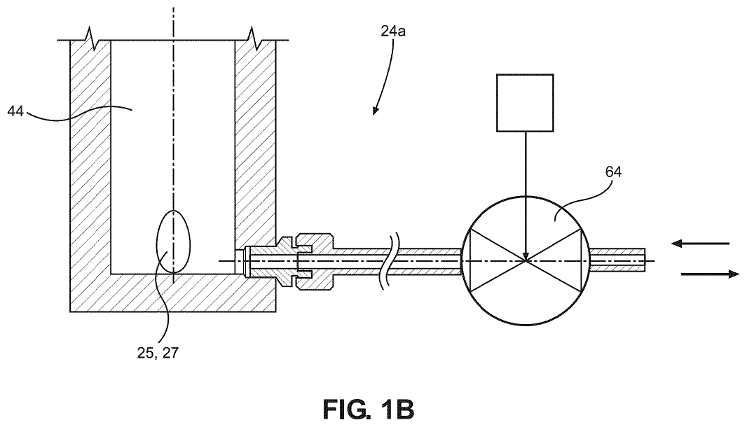

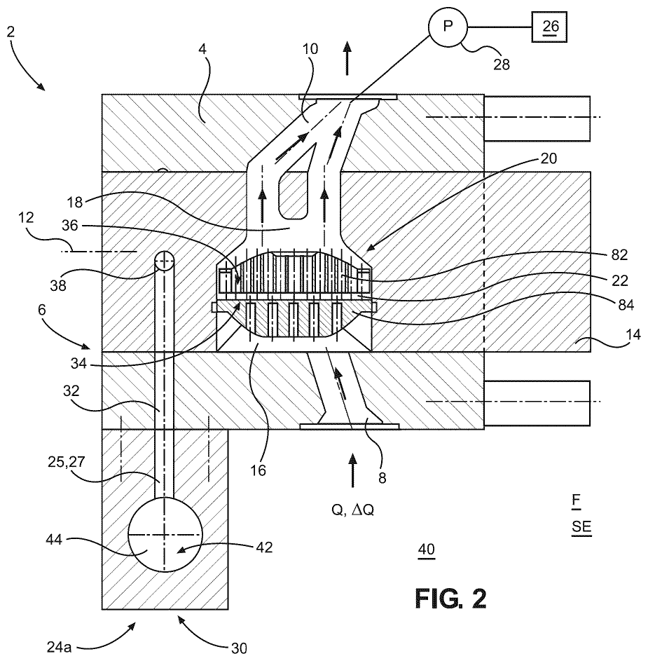

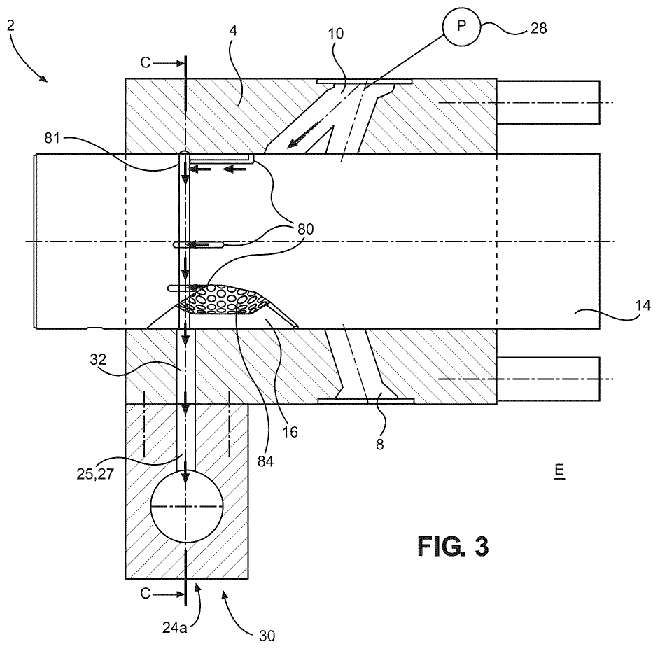

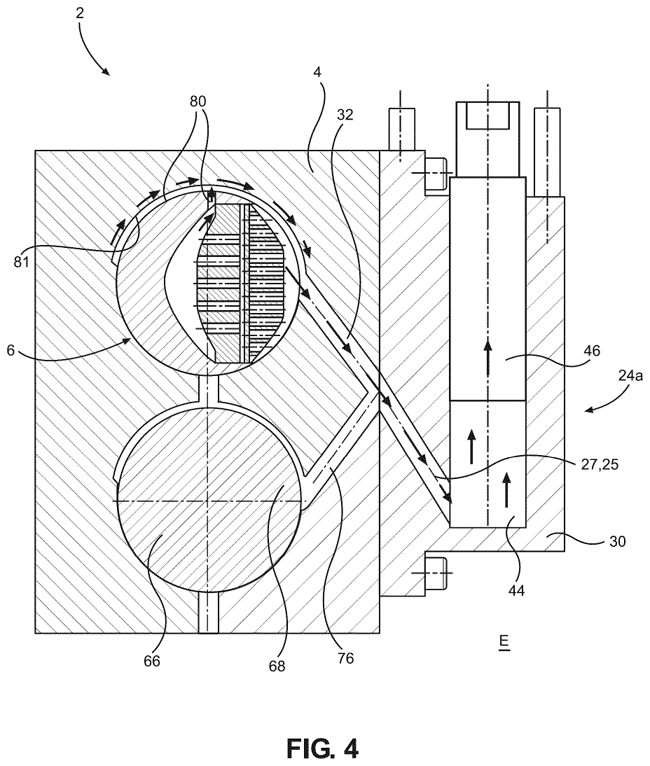

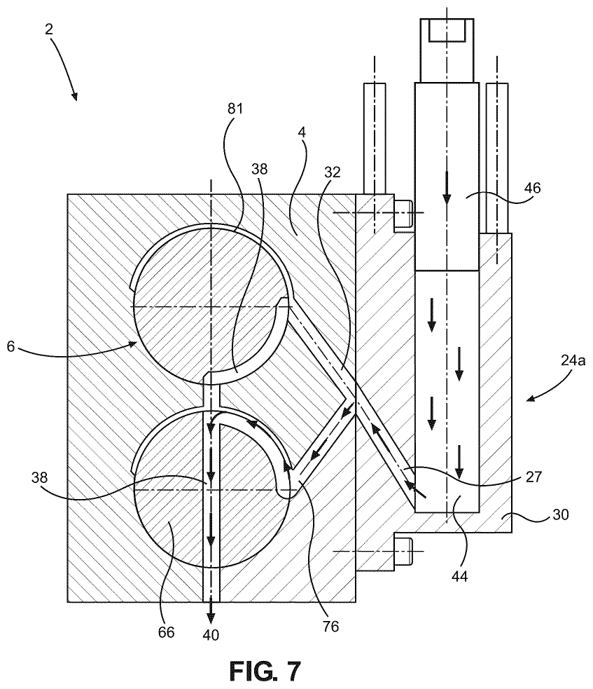

FIGS. 1 to 7 show a first embodiment of a filtering device 2. Filtering device 2 is adapted to filter a fluid, in particular a liquefied plastic. Filtering device 2 has a housing 4. Housing 4 has a receptacle 6 for receiving a screen carrier, and a fluid inlet channel 8 and a fluid outlet channel 10. A screen carrier 14 is movably received along a longitudinal axis 12 inside receptacle 6. Screen carrier 14 has a screen carrier inlet 16, a screen carrier outlet 18 and a cavity 20 in which filter element 22 is received. Cavity 20 is in fluid communication with screen carrier inlet 16 and screen carrier outlet 18. Screen carrier 14 can be moved from a filtering position F shown in FIG. 2 into a screen replacement position S, which is shown in FIG. 1a, and into a venting position or venting position area E which is shown in FIGS. 3 and 4.

Filtering device 2 further comprises an accumulator 24a-c which is fluidically connectable to screen carrier inlet 16 and adapted to store the fluid fed via screen carrier inlet 16 and to control the feeding of the fluid into accumulator 24. According to an alternative embodiment not shown here, it is also conceivable that the accumulator is fluidically connectable to screen carrier outlet 18 and adapted to store fluid fed via screen carrier outlet 18 and to control the feeding of the fluid into accumulator 24 accordingly.

Filtering device 2 has a control unit 26. Control unit 26 is configured to control the feeding of fluid into the accumulator 24 in such a way that a volumetric flow rate Q of the melt, in particular a volumetric flow rate Q of the melt leaving filtering device 2 and fed to downstream system components, stays within a definable range of volumetric flow rate ΔQ. Changes in the volumetric flow rate Q of the melt are preferably determined indirectly, in particular alternatively, by means of a pressure sensor 28 arranged in fluid outlet channel 10. In the embodiment shown, accumulator 24 is arranged in a separate housing 30 which is connected to housing 4 of filtering device 2. Housing 4 has an accumulator connecting channel 32 which fluidically connects screen carrier inlet 16 to an accumulator inlet 57, depending on the position of screen carrier 14 relative to housing 4. Screen carrier 14 is driven by a screen carrier drive means 78. Screen carrier 14 also has venting grooves 80. At least one housing venting groove 81, also referred to as a collecting groove, is arranged in housing 4. Filter element 22, also referred to as a screen, is held in position by a screen support plate 82 and a screen retainer 84.

In venting position area E shown in FIGS. 3 and 4, screen carrier 14 is vented by feeding a fluid via fluid outlet channel 10. In venting position area E, accumulator connecting channel 32 provides fluid communication between screen carrier inlet 16 and the outlet 27 of accumulator 24.

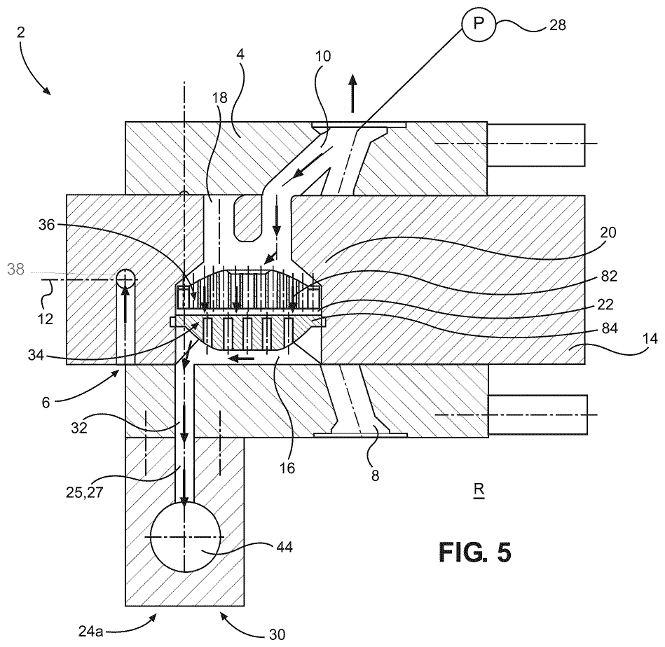

As shown in FIG. 5, screen carrier 14 can also be moved into a backflush position area R. In backflush position area R, backflush fluid is fed to filter element 22 from a clean side 36 of filter element 22 to the dirt side 34 of filter element 22. In backflush position area R, accumulator connecting channel 32 provides fluid communication between screen carrier inlet 16 and the inlet 25 of accumulator 24.

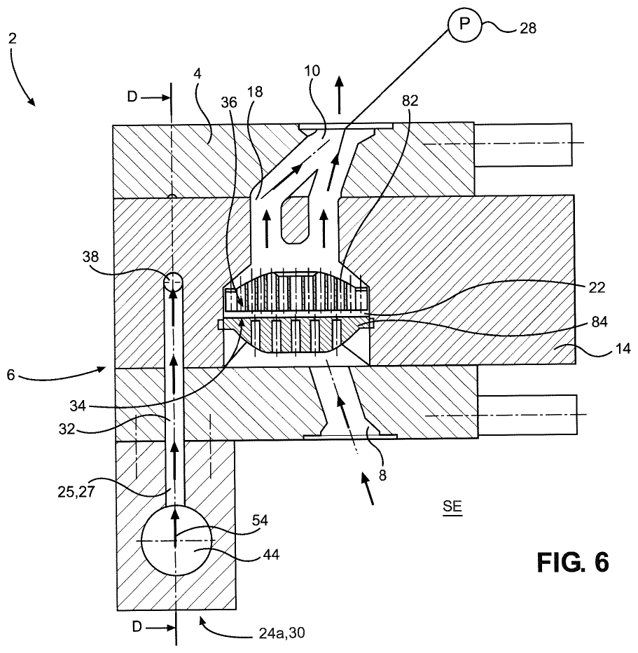

The screen carrier 14 also has an outlet channel 38. In the accumulator emptying position SE, which is shown in FIG. 6, for example, outlet channel 38 provides accumulator connecting channel 32 with fluid communication with surroundings 40 of filtering device 2, such that fluid received in accumulator 24 can be discharged to the surroundings 40. In the accumulator emptying position SE, accumulator connecting channel 32 is also disconnected from screen carrier inlet 16. As shown in FIG. 2 or FIG. 6, the accumulator emptying position SE of screen carrier 14 matches the filtering position F of screen carrier 14.

In the first embodiment of filtering device 2 shown in FIGS. 1-7, accumulator 24a is embodied as a piston accumulator 42. Piston accumulator 42 has an accumulator chamber 44 and a piston 46 which is arranged in accumulator chamber 44 and which can be driven by an actuator 48. The position of actuator 48 is measured by means of a position measuring device 19. The feeding of fluid into accumulator 24, i.e. a mass or volumetric flow, in particular, is controlled by piston 46, in particular by its translational movement. Actuator 48 is embodied as a lift cylinder 50. Lift cylinder 50 is configured to drive the piston 46 along the longitudinal axis 54 of the accumulator. As shown in detail in FIG. 1b, accumulator 24a has a control valve 64. Control valve 64 is connected to accumulator chamber 44 and is configured to apply pressure to accumulator chamber 44 or to vent it. As indicated in FIG. 4, for example, and as can also be seen from FIG. 1a, screen carrier 14 is a first screen carrier 14, wherein filtering device 2 has a second screen carrier 66 which is movably received in housing 4. As illustrated in FIG. 4, screen carrier 66 has a second screen carrier inlet 68. In this regard, housing 4 has at least a second accumulator connecting channel 76 which fluidically connects the second screen carrier inlet 68 to the inlet 25 of accumulator 24a, depending on the position of the second screen carrier 66 relative to housing 4.

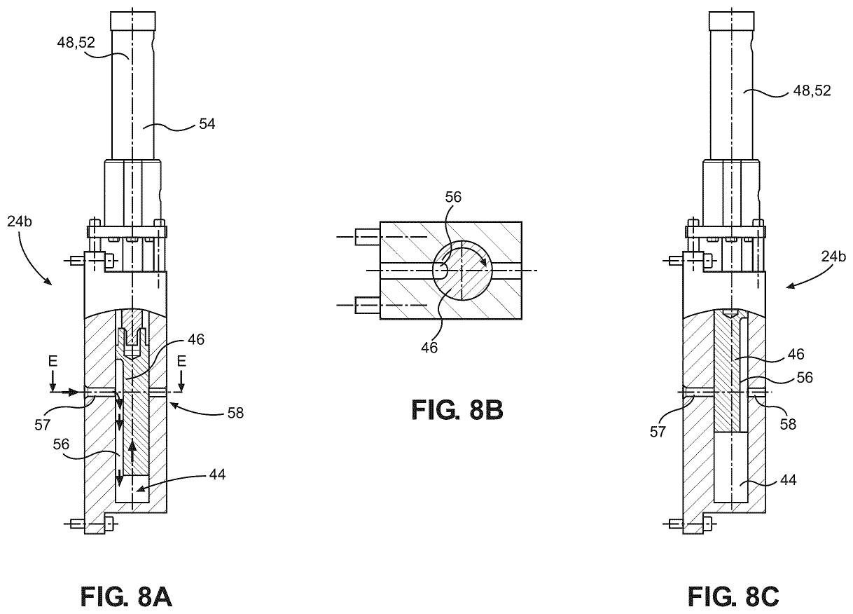

In the embodiment of an accumulator 24b shown in FIGS. 8a-8c, actuator 48 is embodied as a rotary lift cylinder 52. Rotary lift cylinder 52 is configured to drive the piston 46 along the accumulator's longitudinal axis 54 and rotationally inside accumulator chamber 44. Piston 46 has a longitudinal groove 56. Longitudinal groove 56 is designed to interact in such a way with a piston accumulator inlet 57 and a piston accumulator outlet 58 that fluid communication with piston accumulator inlet 57 or piston accumulator outlet 58 is released according to the rotational position of piston 46.

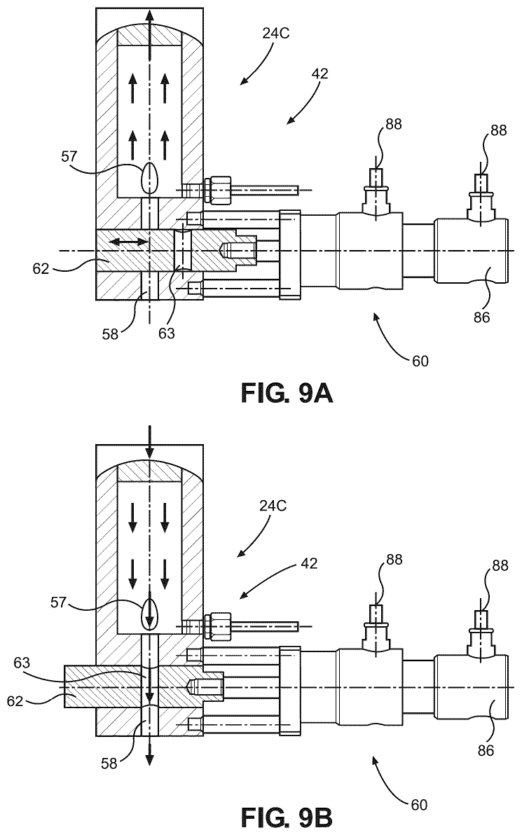

FIGS. 9a and 9b show another alternative embodiment of an accumulator 24c. Accumulator 24c shown therein is embodied as a piston accumulator 42 and has a piston accumulator outlet 58 and a valve 60 having a valve pin 62. Piston accumulator outlet 58 is blocked or released according to the position of valve pin 62 relative to piston accumulator outlet 58, which valve pin has a valve pin passage 63. FIGS. 9a and 9b also show an actuator outlet valve 86 and an outlet valve position detector 88.

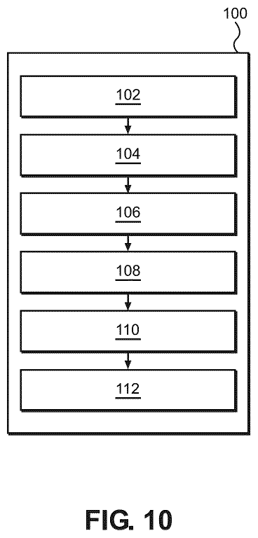

FIG. 10 shows an embodiment of a method 100 for venting a filtering device 2. The method comprises the steps of: moving 102 a screen carrier 14 of filtering device 2 into a venting position area E, feeding 104 venting fluid via a fluid outlet channel 10 of filtering device 2, such that the air in the cavity 20 of the screen carrier is displaced towards a screen carrier inlet 16, feeding 106 the displaced air and/or the venting fluid from screen carrier inlet 16 to an accumulator 24, wherein the feeding of the fluid into accumulator 24 is controlled in such a way that a volumetric flow rate Q of the melt, in particular a volumetric flow rate Q of the melt leaving filtering device 2 and fed to downstream system components, stays within a definable range of volumetric flow rate ΔQ, closing 108 an inlet 25 of accumulator 24, opening 110 an outlet 27 of accumulator 24, expelling 112 the fluid in accumulator 24 out of accumulator 24 via outlet 27.

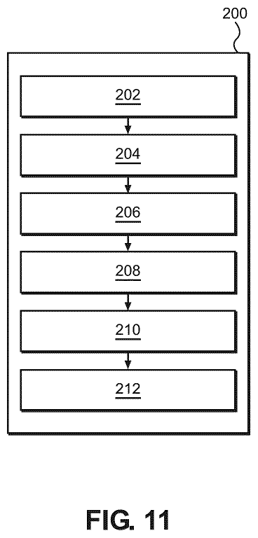

FIG. 11 shows an embodiment of a method 200 for venting a filtering device 2, in particular a filtering device 2 according to any one of the embodiments above. Method 200 comprises the steps of: moving 202 a screen carrier 14 of filtering device 2 into a venting position area E, feeding 204 venting fluid via a fluid inlet channel 8 of filtering device 2, such that the air in the at least one cavity 20 of screen carrier 14 is displaced towards screen carrier outlet 18, feeding 206 the displaced air and/or venting fluid from screen carrier outlet 18 to an accumulator 24, wherein the feeding of the fluid into accumulator 24 is controlled in such a way that a volumetric flow rate Q of the melt, in particular a volumetric flow rate Q of the melt leaving the filtering device and fed to downstream system components, stays within a definable range of volumetric flow rate ΔQ, closing 208 an inlet 25 of accumulator 24, opening 210 an outlet 27 of accumulator 24, expelling 212 the fluid in accumulator 24 out of accumulator 24 via outlet 27.

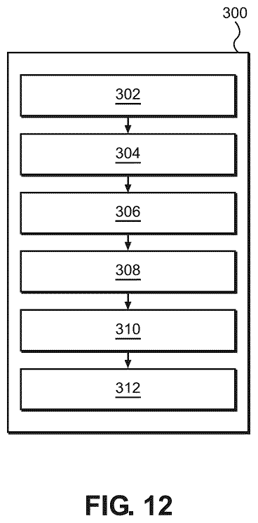

FIG. 12 shows an embodiment of a method 300 for backflushing a filtering device 2, in particular a filtering device 2 according to any one of the embodiments above. Method 300 comprises the steps of: moving 302 a screen carrier 14 of filtering device 2 into a backflush position area RS, feeding 304 backflush fluid via a fluid outlet channel 10 of filtering device 2, such that backflush fluid is fed to a filter element 22 from the clean side 36 of filter element 22 to the dirt side 34 and the backflushed fluid is pressed towards a screen carrier inlet 16, feeding 306 the backflushed fluid from screen carrier inlet 16 to an accumulator 24, wherein the feeding of the fluid into accumulator 24 is controlled in such a way that a volumetric flow rate Q of the melt, in particular a volumetric flow rate Q of the melt leaving filtering device 2 and fed to downstream system components, stays within a definable range of volumetric flow rate ΔQ, closing 308 an inlet 25 of accumulator 24, opening 310 an outlet 27 of accumulator 24, expelling 312 the fluid contained in accumulator 24 out of accumulator 24 via outlet 27.

The steps of closing 108 inlet 25 and opening 110 outlet 27 are carried out by moving screen carrier 14 into an accumulator emptying position SE, in which an accumulator connecting channel 32 provides fluid communication between accumulator 24 and surroundings 40 of filtering device 2 and screen carrier inlet 16 is disconnected.

### LIST OF REFERENCE SIGNS

2 Filtering device
4 Housing
6 Screen carrier receptacle
8 Fluid inlet channel
10 Fluid outlet channel
12 Longitudinal axis of the receptacle
14 (First) screen carrier
16 (First) screen carrier inlet
18 (First) screen carrier outlet
19 Position measuring device
20 (First) cavity
22 Filter element
24a-c Accumulator
25 Inlet of the accumulator
26 Control unit
27 Outlet of the accumulator
28 Pressure sensor
30 Separate housing
32 Reservoir connecting channel
34 Dirt side of the filter element
36 Clean side of the filter element
38 Outlet channel
40 Surroundings of the filtering device
42 Piston accumulator
44 Storage chamber
46 Piston
48 Actuator
50 Lift cylinder
52 Rotary lift cylinder
54 Longitudinal axis of the accumulator
56 Longitudinal groove
57 Piston accumulator inlet
58 Piston accumulator outlet
60 Valve
62 Valve pin
63 Valve pin passage
64 Control valve
66 Second screen carrier
68 Second screen carrier inlet
76 Second accumulator connecting channel
78 Screen carrier drive means
80 Venting grooves in the screen carrier
81 Housing venting groove
82 Screen support plate
84 Screen retainer
86 Actuator outlet valve
88 Outlet valve position detector
100 Method for venting a filtering device
102 Moving a screen carrier into a venting position area
104 Feeding venting fluid via a fluid outlet channel
106 Feeding the displaced air and/or the venting fluid to an accumulator
108 Closing an inlet of the accumulator
110 Opening an outlet of the accumulator
112 Discharging the fluid out of the accumulator
200 Method for venting a filtering device
202 Moving a screen carrier into a venting position area
204 Feeding venting fluid via a fluid inlet channel
206 Feeding the displaced air and/or the venting fluid to an accumulator
208 Closing an inlet of the accumulator
210 Opening an outlet of the accumulator
212 Discharging the fluid out of the accumulator
300 Method for backflushing a filtering device
302 Moving a screen carrier into a backflush position area
304 Feeding backflush fluid via a fluid outlet channel of the filtering device
306 Feeding the backflushed fluid from the screen carrier inlet to an accumulator
308 Closing an inlet of the accumulator
310 Opening an outlet of the accumulator
312 Discharging the fluid out of the accumulator
E Venting position area
F Filtering position
Q Volumetric flow rate of the melt
ΔQ Range of volumetric flow rate
R Backflush position area
S Screen replacement position
SE Accumulator emptying position

1.-21. (canceled)

22. A filtering device for filtering a fluid, in particular a liquefied plastic, comprising:
a housing having a receptacle for receiving a screen carrier, and having a fluid inlet channel and a fluid outlet channel;
a screen carrier movably received along a longitudinal axis inside the receptacle and having a screen carrier inlet, a screen carrier outlet and a cavity for receiving a filter element, wherein the cavity is in fluid communication with the screen carrier inlet and the screen carrier outlet;
the screen carrier can be moved from a screen replacement position(S) via a venting position area into a filtering position (F); and
an accumulator which is fluidically connectable to the screen carrier inlet and/or to the screen carrier outlet and which is configured to store fluid that is fed via the screen carrier inlet and/or the screen carrier outlet and to control a feeding of the fluid into the accumulator in such a way that a volumetric flow rate (Q) of a melt, in particular the volumetric flow rate (Q) of the melt that leaves the filtering device and is fed to downstream system components, stays within a definable range of volumetric flow rate (ΔQ).

23. The filtering device according to claim 22,
wherein the filtering device has a control unit which is configured to control the feeding of fluid into the accumulator in such a way that a volumetric flow rate (Q) of the melt, in particular a volumetric flow rate (Q) of the melt that leaves the filtering device and is fed to downstream system components, stays within a definable range of volumetric flow rate (ΔQ).

24. The filtering device according to claim 23,
wherein the volumetric flow rate (Q) of the melt is determined by means of a pressure sensor which is preferably arranged in the filtering device, in particular in the fluid outlet channel.

25. The filtering device according to claim 22,
wherein the accumulator is arranged in a separate housing or in the housing.

26. The filtering device according to claim 22,
wherein the housing has an accumulator connecting channel which fluidically connects the screen carrier inlet to an accumulator inlet, depending on a position of the screen carrier relative to the housing.

27. The filtering device according to claim 26,
wherein the screen carrier is vented in the venting position area by feeding a fluid via the fluid outlet channel, and wherein the accumulator connecting channel provides fluid communication between the screen carrier inlet and an inlet of the accumulator in the venting position area.

28. The filtering device according to claim 26,
wherein the screen carrier can be brought into a backflush position area (R) in which backflush fluid is fed to the filter element from a clean side of the filter element to a dirt side of the filter element,
wherein the accumulator connecting channel provides fluid communication, in the backflush position area (R), between the screen carrier inlet and an inlet of the accumulator.

29. The filtering device according to claim 22,
wherein the screen carrier has an outlet channel that provides the accumulator a connecting channel with fluid communication with surroundings of the filtering device when the screen carrier is in an accumulator emptying position (SE), such that fluid received in the accumulator can be discharged to the surroundings, and wherein the accumulator connecting channel is disconnected from the screen carrier inlet in the accumulator emptying position (SE).

30. The filtering device according to claim 29,
wherein the accumulator emptying position (SE) of the screen carrier matches the filtering position (F) of the screen carrier.

31. The filtering device according to claim 22,
wherein the accumulator is embodied as a piston accumulator.

32. The filtering device according to claim 31,
wherein the piston accumulator has an accumulator chamber and a piston which is arranged in the accumulator chamber and can be driven by an actuator, and wherein the feeding of the fluid into the accumulator is controlled by the piston.

33. The filtering device according to claim 32,
wherein the actuator is embodied as a lift cylinder which is configured to drive the piston along the longitudinal axis of the accumulator.

34. The filtering device according to claim 32, wherein the actuator is embodied as a rotary lift cylinder which is configured to drive the piston along the longitudinal axis of the accumulator and rotationally inside the accumulator chamber, wherein the piston has a longitudinal groove which interacts in such a way with a piston accumulator inlet and a piston accumulator outlet that fluid communication with the piston accumulator inlet or the piston accumulator outlet is released according to a rotational position of the piston.

35. The filtering device according to claim 31,
wherein the piston accumulator has a piston accumulator outlet and a valve having a valve pin, wherein the piston accumulator outlet is blocked or released according to a position of the valve pin relative to the piston accumulator outlet.

36. The filtering device according to claim 32,
wherein the accumulator has a control valve which is connected to the accumulator chamber and is configured to apply pressure to the accumulator chamber or to vent it.

37. The filtering device according to claim 22,
wherein the screen carrier is a first screen carrier and wherein the filtering device has at least a second screen carrier movably received in the housing and having a second screen carrier inlet,
wherein the housing has at least a second accumulator connecting channel which fluidically connects the second screen carrier inlet to an inlet of the accumulator, depending on a position of the second screen carrier relative to the housing.

38. A method for venting a filtering device, in particular a filtering device according to claim 22, comprising:
moving a screen carrier of the filtering device into a venting position area,
feeding a venting fluid via a fluid outlet channel of the filtering device, such that air in the cavity of the screen carrier is displaced towards a screen carrier inlet,
feeding displaced air and/or the venting fluid from the screen carrier inlet to an accumulator, wherein the feeding of the fluid into the accumulator is controlled in such a way that a volumetric flow rate (Q) of the melt, in particular a volumetric flow rate (Q) of the melt that leaves the filtering device and is fed to downstream system components, stays within a definable range of volumetric flow rate (ΔQ).

39. A method for venting a filtering device, in particular a filtering device according to claim 22, comprising:
moving a screen carrier of the filtering device into a venting position area,
feeding a venting fluid via a fluid inlet channel of the filtering device, such that air in at least one cavity of the screen carrier is displaced towards a screen carrier outlet,
feeding displaced air and/or the venting fluid from the screen carrier outlet to an accumulator, wherein the feeding of the fluid into the accumulator is controlled in such a way that a volumetric flow rate (Q) of the melt, in particular a volumetric flow rate (Q) of the melt that leaves the filtering device and is fed to downstream system components, stays within a definable range of volumetric flow rate (ΔQ).

40. A method for backflushing a filtering device, in particular a filtering device according to claim 22, comprising:
moving a screen carrier of the filtering device into a backflush position area (RS),
feeding a backflush fluid via a fluid outlet channel of the filtering device, such that backflush fluid is fed to a filter element from a clean side of the filter element to a dirt side and the backflushed fluid is pressed towards a screen carrier inlet,
feeding the backflushed fluid from the screen carrier inlet to an accumulator, wherein the feeding of the fluid into the accumulator is controlled in such a way that a volumetric flow rate (Q) of the melt, in particular a volumetric flow rate (Q) of the melt that leaves the filtering device and is fed to downstream system components, stays within a definable range of volumetric flow rate (ΔQ).

41. The method according to claim 38, comprising:
closing an inlet of the accumulator,
opening an outlet of the accumulator,
discharging the fluid contained in the accumulator out of the accumulator via the outlet.

42. The method according to claim 41, wherein the closing the inlet and opening the outlet are carried out by moving the screen carrier into an accumulator emptying position (SE) in which an accumulator connecting channel provides fluid communication between the accumulator and surroundings of the filtering device and the screen carrier inlet is disconnected.
